(19) United States
(12) Patent Application Publication
(10) Pub. No.: US 2012/0112111 A1
(43) Pub. Date: May 10, 2012

(54) PRESSURE REGULATING VALVE, IN PARTICULAR FOR ACTIVATING A CLUTCH IN A MOTOR VEHICLE AUTOMATIC TRANSMISSION

(76) Inventor: Werner Schmid, Weinstadt (DE)

(21) Appl. No.: 13/289,704

(22) Filed: Nov. 4, 2011

(30) Foreign Application Priority Data
Nov. 10, 2010 (DE) 102010043697.6

(51) Int. Cl. F16K 1/42

(52) U.S. Cl. 251/318

(57) ABSTRACT

A pressure regulating valve for activating a clutch in a motor vehicle automatic transmission, having a housing having a first transverse opening which acts as a fluid inlet, and a second transverse opening which acts at least temporarily as a fluid outlet, the two transverse openings being spaced axially from one another, and having a valve slide guided in the housing, the valve slide including an axially extending recess in its circumferential surface, the recess fluidically connecting the two transverse openings to one another in a first axial position of the valve slide and separating them from one another in a second axial position, in the circumferential surface of the valve slide the recess having a face having an undercut at its end closest to the second transverse opening.

### BACKGROUND INFORMATION

Pressure regulators for activating clutches in automatic transmissions of motor vehicles are known from the market. These pressure regulators are activated with the aid of an electromagnet which is able to bring an axially displaceable piston of a slide valve into at least two end positions or switching positions. When the electromagnet is energized, the piston is displaced axially, so that a control edge of the piston may clear an opening of the slide valve, making it possible, for example, for a fluid stream to flow into an actuator of a clutch.

In addition, the fluid stream flowing through the opening generates an axial force component which becomes greater the stronger the direction of the fluid stream deviates from the desired radial direction. The axial force component counteracts the force of the electromagnet and reduces the fluid stream flowing through the opening. However, this adversely affects the requirement placed on modern automatic transmissions for comparatively great flow rates and short shifting times.

Patent publications from this technical field are, for example, European Patent No. EP 1 703 178.

### SUMMARY OF THE INVENTION

A problem underlying the present invention is solved by a pressure regulating valve according to the present invention.

The method according to the present invention has the advantage that when a pressure regulating valve is activated, an axial force component caused by the resulting fluid stream is relatively small, and a flow rate and/or switching speed of the pressure regulating valve is relatively great. Simultaneously, the pressure regulating valve according to the present invention functions in a particularly robust manner, since a housing of the pressure regulating valve only has radial openings in the form of transverse openings; however, it is not necessarily required to have an annular groove or a circumferential control edge.

The pressure regulating valve according to the present invention includes at least two hydraulic connections, each of which is designed as a transverse opening in the (mostly cylindrical) housing of the pressure regulating valve. It is understood that the “transverse openings” may be designed as circular transverse bores or alternatively have a cross section which deviates from the circular shape. For example, they may also be designed as channels having an elliptical or rectangular cross section. With the aid of an axially extending recess of a valve slide situated in the pressure regulating valve, the hydraulic connections may be fluidically connected to one another and/or separated from one another as a function of an axial position of the valve slide. According to the present invention, the axial fluid stream produced in some areas in the pressure regulating valve is diverted radially in the direction of the second transverse opening which acts at least temporarily as a fluid outlet, a face having an undercut at its end closest to the second transverse opening in a circumferential surface of the valve slide. This makes it possible for the fluid flow on the face of the valve slide which is diverted from the axial to the radial direction to be influenced in such a way that axial force components are reduced. Because the housing of the pressure regulating valve has no annular groove in the area of the transverse openings, a required axial stroke of the valve slide may be greater, making the switching characteristics of the pressure regulating valve particularly robust. Another advantage results from the fact that the leakage in a gap between the valve slide and the housing is less.

The pressure regulating valve functions particularly well if an angle of the undercut amounts to approximately 15° to 45°, more preferably approximately 30° in relation to a radial axis of the valve slide. Accordingly, a geometry of the valve slide or of the undercut is described which is suitable in particular for the conduction of flow for a large number of pressure regulating valves.

One embodiment of the pressure regulating valve provides that the transition from an axially extending base of the recess to the undercut face is rounded off. For example, a radius of approximately 0.03 mm (millimeters) in combination with an angle of the undercut of 30° may be a particularly suitable design, which may also represent a good compromise with respect to the manufacturability of the pressure regulating valve.

Furthermore, it is provided that the recess extends over the entire circumference of the valve slide in the manner of an annular groove. As a result, the valve slide has a maximally large axial cross section in the area of the recess, as a result of which the switching characteristics of the pressure regulating valve are improved. Another advantage is due to the fact that an angular orientation of the valve slide is not required.

### BRIEF DESCRIPTION OF THE DRAWINGS

FIG. 1 shows an axial sectional view of a pressure regulating valve.

FIG. 2 shows an axial sectional view of a valve slide of the pressure regulating valve from FIG. 1.

FIG. 3 shows a detailed view of FIG. 2.

FIG. 4 shows a first schematic sectional view of an axial section of a housing and of the valve slide having an undercut.

FIG. 5 shows a detailed view of FIG. 4.

FIG. 6 shows a second schematic sectional view of an axial section of the housing and of the valve slide having an undercut.

FIG. 7 shows a detailed view of FIG. 6.

### DETAILED DESCRIPTION

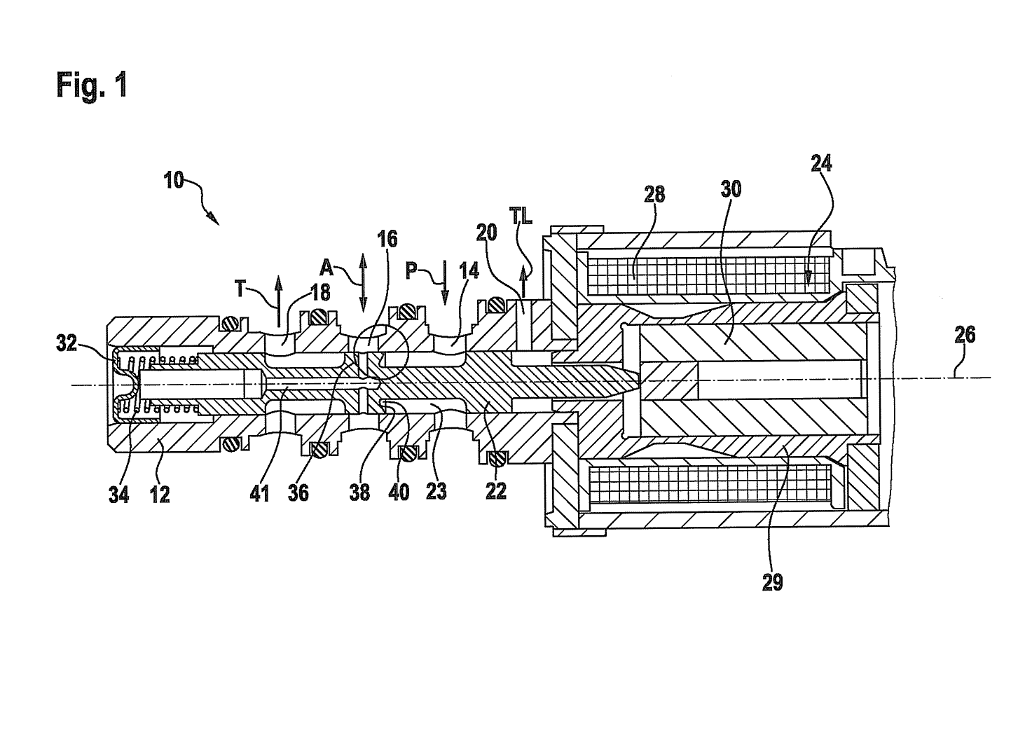

FIG. 1 shows an axial sectional view of a pressure regulating valve 10 for activating a clutch in a motor vehicle automatic transmission. It includes a cylindrical housing 12 having a first transverse opening designed as a transverse bore 14 and a second transverse opening designed as a transverse bore 16, which, when seen in the direction of a longitudinal axis 26 (“axial spacing”), are spaced apart from one another and having additional transverse bores 18 and 20. A valve slide 22 coaxial to housing 12 is situated in housing 12. Valve slide 22 may be displaced axially by an electromagnet 24 in the direction of longitudinal axis 26. In the present case, valve slide 22 designed in the shape of a piston has three recesses 23 extending in the direction of longitudinal axis 26 (“axial extension”), each of the recesses extending over the entire circumference of valve slide 22 in the manner of an annular groove. Only center recess 23 in the drawing is provided with a reference numeral. Electromagnet 24 includes a coil 28, a magnetic pole 29 and an armature 30 which acts on valve slide 22. A coil spring 34 is situated between an end section of valve slide 22 and a receptacle 32 situated in housing 12 in an area shown to the left in the drawing. In the drawing of FIG. 1, a circle 36 describes a face 38 having an undercut 40 of valve slide 22. A channel 41 which is necessary for the pressure regulation is also shown. Pressure regulating valve 10 is primarily designed to be rotationally symmetrical around longitudinal axis 26.

FIG. 1 shows valve slide 22 in a center axial position in which working connection A is separated from both outflow connection T and inflow connection P. In a “first” axial position which is not shown in FIG. 1, coil 28 is energized and valve slide 22 is in a position to the left in the drawing, working connection A or second transverse bore 16 being hydraulically connected to inflow connection P or first transverse bore 14. In a “second” axial position, which is also not shown in FIG. 1, coil 28 is not energized and valve slide 22 is in a position to the right in the drawing, working connection A or second transverse bore 16 being hydraulically connected to an outflow connection T or transverse bore 18. In the second axial position, transverse bore 14 is fluidically separated from transverse bore 16.

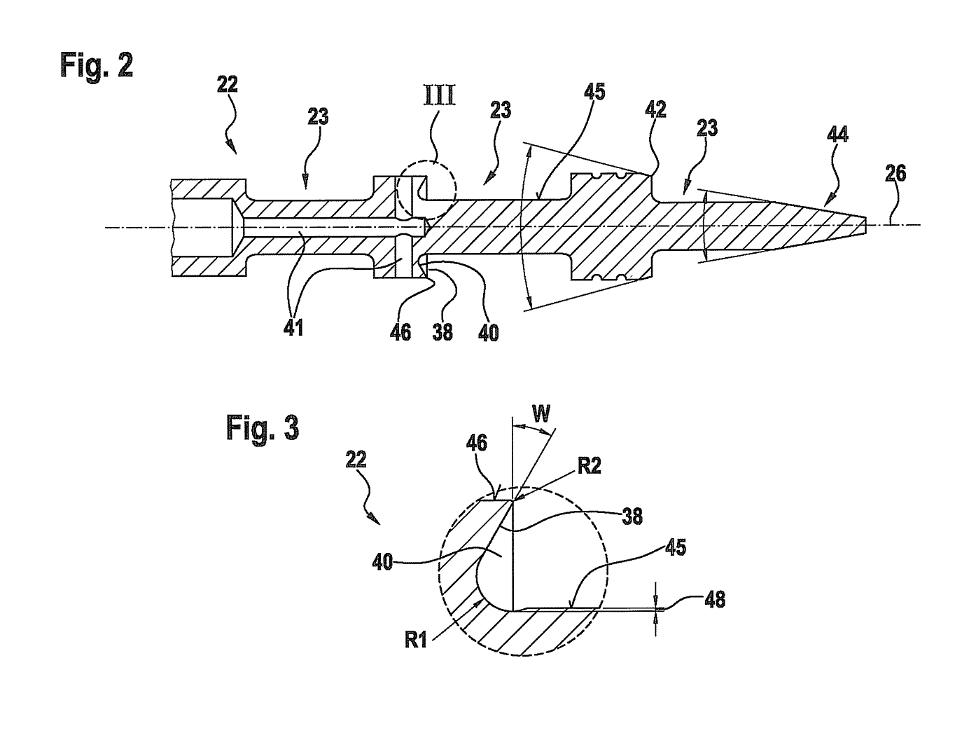

FIG. 2 shows an axial sectional view of valve slide 22, which is slightly enlarged in relation to FIG. 1. In the present case, a control edge 42 and an armature-side end section 44 have a phase or incline of approximately 10° in relation to longitudinal axis 26. Center recess 23 has an axially extending base 45. The radial outside edge of face 38 forms a control edge 46.

FIG. 3 shows a detailed view III of FIG. 2. Undercut 40 in face 38 is designed having an angle W of 30° in relation to a radial axis of valve slide 22. Furthermore, undercut 40 has a first radius R1 between face 38 and base 45 and a fillet having a second radius R2 on control edge 46. The transition from axially extending base 45 of recess 23 to undercut face 38 is thus slightly rounded off. An undersize 48 of undercut 40 in relation to base 45 amounts to approximately 0.05 mm (millimeter) or less in the present case.

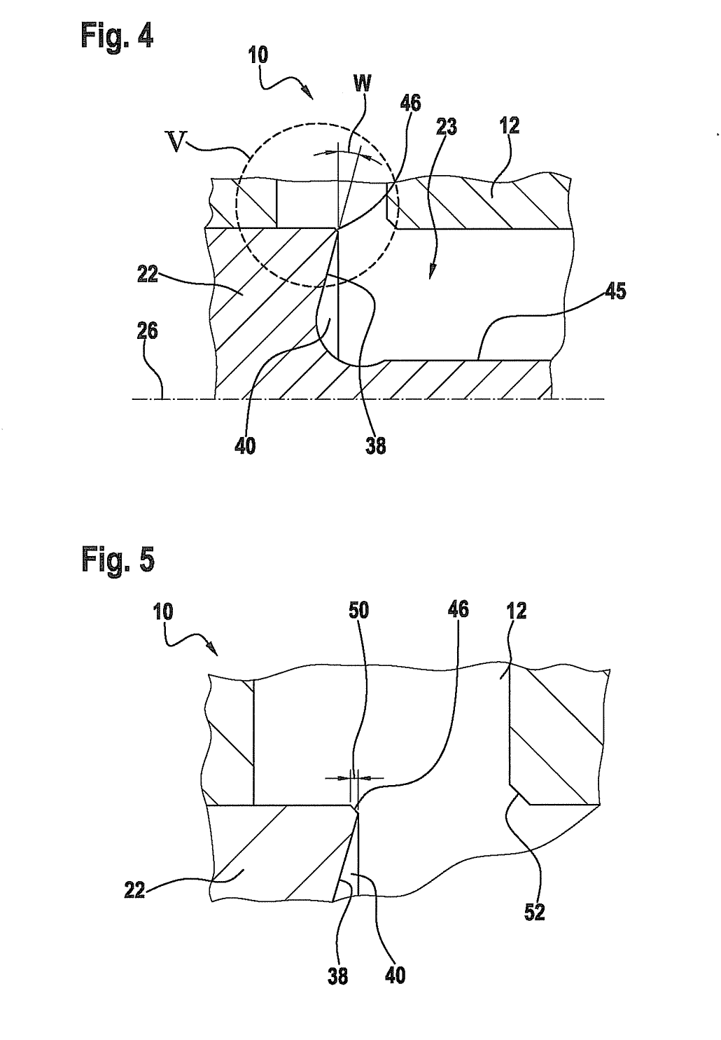

FIG. 4 shows a first schematic sectional view of an axial section in the area of circle 36 of valve slide 22. FIG. 5 shows a detailed view V of FIG. 4. In the present case, angle W of undercut 40 amounts to approximately 15°. Attention is also drawn to 45° inclines in the area of control edge 46 and a phase 52.

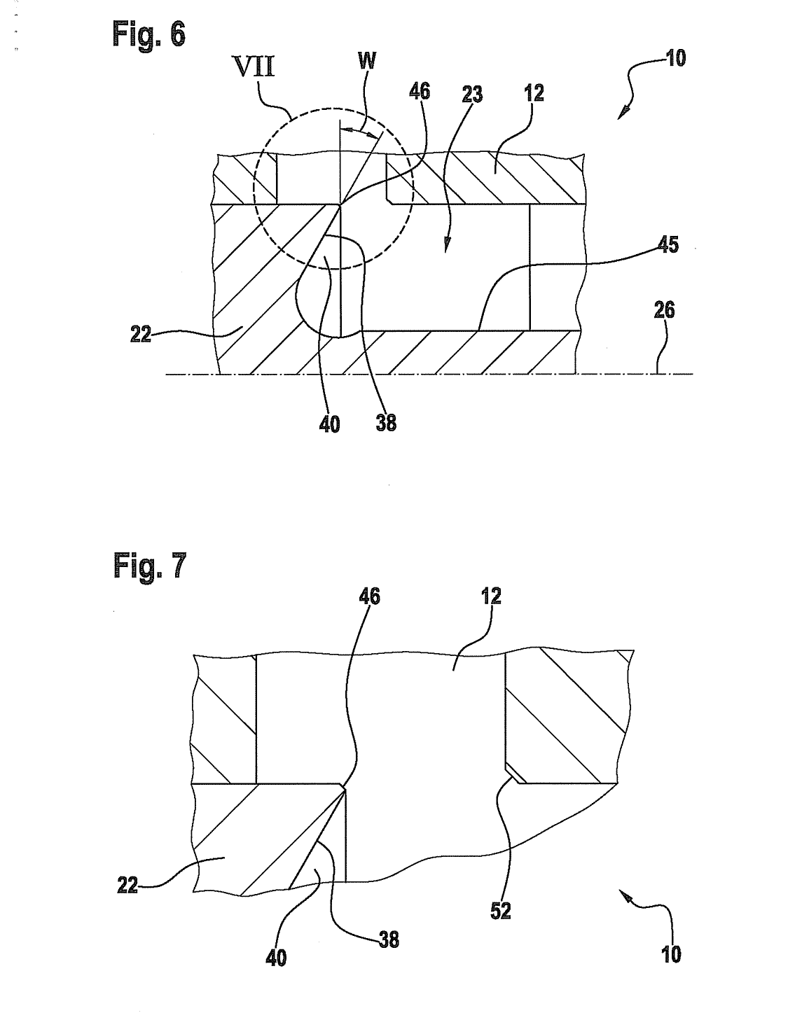

FIG. 6 shows a second schematic sectional view similar to that of FIG. 4. Likewise, FIG. 7 in turn shows a detailed view VII of FIG. 6. In the present case, angle W amounts to approximately 30°; however, it could also amount to 45°.

If electromagnet 24 or coil 28 is energized, the magnetic force displaces armature 30 axially to the left in the drawing of FIG. 1 until transverse bores 14 and 16 are fluidically connected to one another. In pressure regulating valve 10, an essentially horizontal fluid stream from inflow connection P to working connection A is formed in center recess 23. In the area of circle 36, the fluid stream is diverted radially to the outside to transverse bore 16.

What is claimed is:

1. A pressure regulating valve comprising:
a housing having two transverse openings; and
a valve slide guided in the housing, wherein the valve slide, on its circumferential surface, includes a recess extending in a longitudinal direction of the valve slide, wherein the recess fluidically connects the two transverse openings in the housing to one another in a first axial position of the valve slide and separates the two transverse openings from one another in a second axial position, wherein the recess has a face having an undercut at its end closest to at least one of the transverse openings.

2. The pressure regulating valve according to claim 1, wherein an angle of the undercut is about 15° to 45°, in relation to a radial axis of the valve slide.

3. The pressure regulating valve according to claim 2, wherein the angle of the undercut is about 30°.

4. The pressure regulating valve according to claim 1, wherein a transition from an axially extending base of the recess to the undercut face is rounded off.

5. The pressure regulating valve according to claim 1, wherein the recess extends over an entire circumference of the valve slide in the manner of an annular groove.

6. The pressure regulating valve according to claim 1, wherein the valve is for activating a clutch in an automatic transmission of a motor vehicle.

7. The pressure regulating valve according to claim 1, wherein the at least one of the transverse openings is a transverse opening used as a fluid outlet.
